(19) United States
(12) Patent Application Publication
(10) Pub. No.: US 2020/0387719 A1
(43) Pub. Date: Dec. 10, 2020

(54) VISUALIZATION OF PREDICTED CROWD BEHAVIOR FOR SURVEILLANCE

(71) Applicant: Xinova, LLC, Seattle, WA (US)

(72) Inventor: Yang-Won JUNG, Seoul (KR)

(73) Assignee: Xinova, LLC, Seattle, WA (US)

(21) Appl. No.: 16/957,318

(22) PCT Filed: Jan. 4, 2018
(86) PCT No.: PCT/US18/12379

§ 371 Date: Jun. 23, 2020

(51) Int. Cl. G06K 9/00; G06K 9/62; H04N 5/265; G06T 7/20; H04N 7/18; G06T 11/00; G10L 25/57; H04R 1/08

(52) U.S. Cl. CPC G06K 9/00778; G06K 9/00335; G06K 9/6215; H04N 5/265; G06T 7/20; H04N 7/181; G06T 2207/10016; G10L 25/57; H04R 1/08; G06T 2207/30196; G06T 2207/30232; G06T 2207/30242; G06T 11/00

(57) ABSTRACT

Technologies are described for visualization of current and predicted crowd behavior information for surveillance. In surveillance systems, a variety of image capture devices and audio capture devices may be positioned strategically throughout a building or an area. The capture devices may transmit respective audio and video signals to a display device, such as a monitor in a surveillance control room, and to a signal processor for crowd behavior analysis. A signal processor, according to some examples, may receive crowd characteristics for an area, derive current crowd behavior information from the crowd characteristics, and predict crowd behavior information based on crowd characteristics, area characteristics, normalized crowd behavior information (from other areas), and/or external information. The signal processor may provide current and predicted crowd behavior information to a display device. The display device may overlay a corresponding video signal with a visualization of the current and predicted crowd behavior information.

### BACKGROUND

Unless otherwise indicated herein, the materials described in this section are not prior art to the claims in this application and are not admitted to be prior art by inclusion in this section.

Typical surveillance systems may be comprised of a variety of image capture devices and audio capture devices positioned strategically throughout a building or an area. The capture devices may transmit respective audio and video signals to a display device, such as a monitor in a surveillance control room. Security personnel may observe a particular video signal to monitor crowds and their behaviors for suspicious activities, among other things. Security personnel may utilize past crowd behaviors in strategic planning for future events.

### SUMMARY

The present disclosure generally describes techniques to predict and visualize crowd behavior for surveillance.

According to some examples, a method to visualize predicted crowd behavior for surveillance may comprise receiving crowd characteristics based on a monitoring of crowds in a plurality of areas, deriving crowd behavior information for each of the plurality of areas based on the received crowd characteristics and external information, identifying two or more areas associated with similar crowd behavior information, correlating one or more differences in the crowd behavior information associated with the two or more areas with area characteristics of the two or more areas, and providing, for presentation, one or more of the crowd behavior information and the area characteristics for each of the two or more areas.

According to other examples, a server may be configured to visualize predicted crowd behavior for surveillance. The server may be comprised of a communication interface which may be configured to facilitate communication between a monitor system and the server and a processor coupled to the communication interface. The processor may be configured to perform or control performance of: receive, from the communication interface, crowd characteristics based on crowds in a plurality of areas being monitored by the monitor system; derive crowd behavior information for each of the plurality of areas based on the received crowd characteristics and external information; identify two or more areas associated with similar crowd behavior information; correlate one or more differences in the crowd behavior information associated with the two or more areas with area characteristics of the two or more areas; normalize the crowd behavior information associated with the two or more areas based on the correlation; and provide, for presentation, the normalized crowd behavior information associated with the two or more areas.

According to further examples, a system may be configured to visualize predicted crowd behavior for surveillance. The system may be comprised of a monitor system, a display device, a server, and a communication interface configured to facilitate communication between the monitor system, the display device, and the server. The monitor system may be configured to monitor crowds in a plurality of areas. The server may comprise a processor configured to: receive, from the communication interface, crowd characteristics based on the monitoring of the crowds in the plurality of areas, wherein the communication interface receives the crowd characteristics from the monitor system; derive crowd behavior information for each of the plurality of areas based on the received crowd characteristics and external information; identify two or more areas associated with similar crowd behavior information; correlate one or more differences in the crowd behavior information associated with the two or more areas with area characteristics of the two or more areas; normalize the crowd behavior information associated with the two or more areas based on the correlation to predict a crowd behavior for a first area of the two or more areas; and provide, to the display device for presentation, the predicted crowd behavior for the first area.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example system configured to visualize predicted crowd behavior for surveillance;

FIG. 2 includes a conceptual illustration of an example method to visualize predicted crowd behavior for surveillance;

FIG. 3 illustrates an example scenario where predicted crowd behavior may be visualized for surveillance of a marathon;

FIG. 4 illustrates another example scenario where predicted crowd behavior may be visualized for surveillance of a sporting event;

FIG. 5 illustrates an example visualization of predicted crowd behavior associated with a main area of a mall;

FIG. 6 illustrates a computing device, which may be used to visualize predicted crowd behavior for surveillance;

FIG. 7 is a flow diagram illustrating an example method to visualize predicted crowd behavior for surveillance that may be performed by a computing device such as the computing device in FIG. 6; and

FIG. 8 illustrates a block diagram of an example computer program product, some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to prediction and visualization of crowd behavior for surveillance.

Briefly stated, technologies are generally described to visualize current and predicted crowd behavior information for surveillance. In surveillance systems, a variety of image capture devices and audio capture devices may be positioned strategically throughout a building or an area. The capture devices may transmit respective audio and video signals to a display device, such as a monitor in a surveillance control room, and to a signal processor for crowd behavior analysis. A signal processor, according to some examples, may receive crowd characteristics for an area, derive current crowd behavior information from the crowd characteristics, and predict crowd behavior information based on crowd characteristics, area characteristics, normalized crowd behavior information (from other areas), and/or external information. The signal processor may provide current and predicted crowd behavior information to a display device. The display device may overlay a corresponding video signal with a visualization of the current and predicted crowd behavior information.

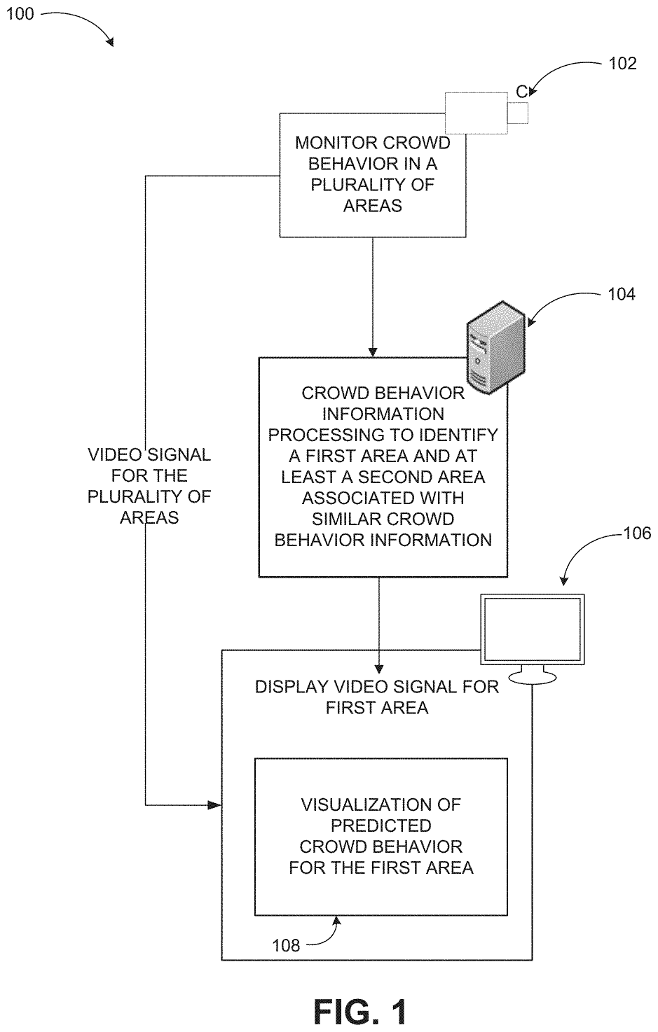

FIG. 1 includes a conceptual illustration of an example system configured to visualize predicted crowd behavior for surveillance, arranged in accordance with at least some embodiments described herein.

Crowd behavior may be an important aspect in surveillance activities. Crowd behavior may influence security decisions such as how many security personnel are to be deployed, to which locations, which instructions should be given to the security personnel, etc. Upon predicting crowd behavior based on a number of factors, security supervisors may select and deploy tools available to them to ensure safety of the people attending an event, for example, surveil suspicious activities, and avoid problematic outcomes. One of the factors that may be considered in determining/predicting crowd behavior is crowd characteristics. Crowd characteristics are typically instantaneous (that is, they include attributes of a crowd at any given moment) and may include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period. External information may also be used in determining/predicting crowd behavior and may include one or more of a type of event associated with the surveillance, a timing of the event, related actions to the event, or a promotion associated with the event. Yet another factor in determining/predicting crowd behavior may include area characteristics, which are attributes of an area where certain crowd characteristics are observed and may include one or more of an area size, an area shape, a structural feature of an area, a decorative item within an area, a functional item within an area, another facility proximal to an area, or external traffic near an area. Crowd behavior information, as used herein, refers to determined or predicted crowd behavior data that is stored, processed, and exchanged in a computerized surveillance/security system.

As shown in diagram 100, a system to predict and visualize crowd behavior for surveillance may include a monitor system 102, a signal processor 104, and a display device 106. The monitor system 102 may include a plurality of image capture devices and a plurality of audio capture devices. The image capture devices and the audio capture devices may be positioned to monitor crowd behavior in a plurality of areas. The image capture devices may include a stationary camera, a mobile camera, a thermal camera, a camera integrated in a mobile device, or a body-mounted camera, for example. The image capture devices may capture a video signal corresponding to the area and may transmit the video signal to the signal processor 104 and the display device 106. The audio capture devices may capture corresponding audio signals and may transmit the audio signals to the signal processor 104. For example, a surveillance system may be implemented to monitor crowds at a stadium during a sporting event. The stadium may have a variety of areas including four entrances, four corridors, two concession stands, and two pairs of restrooms, for example. The surveillance system may include a variety of image capture devices and audio capture devices positioned throughout the areas to monitor crowds during the event. The capture devices may transmit their respective signals to a control room to be monitored by security personnel and to a signal processor, such as a server, for crowd behavior analysis.

In some examples, the signal processor 104 may include a computing device such as a server, a desktop computer, a mobile computer, a special purpose computing device, or a component level processor, for example. In other examples, the signal processor 104 may be integrated with the plurality of devices in the monitor system 102. The signal processor 104 may receive crowd characteristics from the monitor system 102. The crowd characteristics may include a number of people that enter and exit an area during a particular time period, a difference in the number of people that enter and exit an area during the particular time period, a predominant direction of people's movement in the particular time period. The crowd characteristics may also include a difference in direction of people's movement in the particular time period. a speed of people's movement in the particular time period, a variation in speed of people's movement in the particular time period, a flow ratio of people in the particular time period, or a type of people in the particular time period, for example. After receiving the crowd characteristic for a first area, the signal processor 104 may derive crowd behavior information for the first area based on the crowd characteristics from the first area, characteristics of the first area, and/or external information. The external information may include a type of event being monitored, a time of an event, related actions to a particular event, a promotion associated with the event, or a number of (expected) attendees, for example. In some examples, the signal processor 104 may also predict crowd behavior information from crowd characteristics, area characteristics, normalized crowd information, and/or external information. The process for normalizing and predicting crowd information is discussed below in conjunction with subsequent figures. In the example scenario at the stadium, the server may receive a video signal from the first entrance and derive that a crowd is forming outside prior to the start of an event and predict how fast the crowd may move into the stadium.

In some examples, the signal processor 104 may provide the crowd characteristics, the area characteristics, a current crowd behavior, a predicted crowd behavior, and/or a difference between the current crowd behavior and the predicted crowd behavior for the first area to be displayed on one or more display devices 106. The one or more display devices 106 may include a television, a mobile device, a monitor, a projector, or a tablet, for example. The one or more display devices 106 may receive a video signal corresponding to the first area from the monitor system 102 as well as crowd characteristics, area characteristics, and/or a predicted crowd behavior from the signal processor 104. In some examples, one of the display devices 106 may display the video signal for an area and may overlay a visualization 108 of the current and/or predicted crowd behaviors on the corresponding video signal. The visualization 108 may include different textual, graphical, coloring, highlighting, shading, or animation schemes to emphasize a difference between the predicted crowd behavior and the crowd or area characteristics.

In an example scenario, a new security guard may be positioned at the first entrance of the stadium on the night of a basketball game. The server may provide the security guard a video signal from the entrance overlaid with current crowd behavior information, area characteristics, and predicted crowd behavior information. The server may use the normalized crowd behavior information from the other entrances, crowd behavior at the first entrance during previous basketball games, and/or current crowd characteristics to predict current crowd behavior. The new security guard may be able to use the visualization of the current and predicted crowd behavior or differences between the current crowd behavior and the predicted crowd behavior to better anticipate crowd behaviors or threats and if help is needed.

In some examples, statistical crowd behavior information from an area that may be similar to an area under observation may be used as reference for other areas or to predict/anticipate crowd behavior in other areas. The prediction may be for normal crowd behavior or crowd behavior under abnormal circumstances such as an emergency or panic. Using the provided statistically predicted behavior, the security system (including a monitoring agent) may be allowed to distinguish normal (in statistical sense) and abnormal crowd behavior. In further examples, similar areas under observation may be identified and current or past crowd behavior compared for the similar areas. In case of distinction between observed areas, crowd behavior (observed or predicted) may be normalized based on area characteristics (as well as, external information).

In the conceptual diagram 100, the positioning and structure of the monitor system 102, the signal processor 104, the one or more display devices 106, and the visualization 108 have been simplified for clarity. Configurations of the apparatus and/or the monitor system 102, the signal processor 104, the one or more display devices 106, and the visualization 108 are not limited to the configurations illustrated in the diagram 100.

Typical surveillance system configurations, as discussed above, rely on security personnel to observe crowd characteristics in a video signal and determine crowd behaviors manually. Providing a visualization of current and predicted crowd behavior information may allow for more reliable determination and prediction of crowd behaviors, and may also allow security personnel in the field to be more aware of current and predicted crowd behaviors.

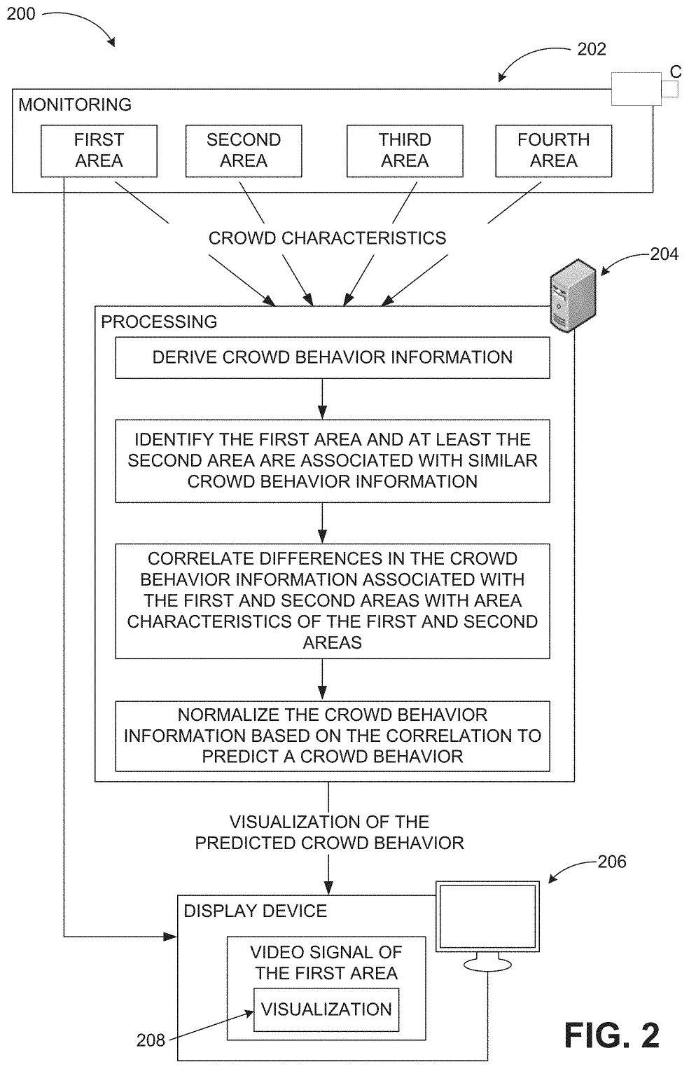

FIG. 2 includes a conceptual illustration of an example method to visualize predicted crowd behavior for surveillance, arranged in accordance with at least some embodiments described herein.

As shown in diagram 200, a security system may include a monitor system 202, a signal processor 204, and one or more display devices 206. The monitor system 202 may monitor a first area, a second area, a third area, and a fourth area with corresponding image capture devices, for example. An image capture device may capture a video signal for a corresponding area and may transmit the video signal to the signal processor 204 and the one or more display devices 206. The image capture devices of the monitor system 202 may include a stationary camera, a mobile camera, a thermal camera, a camera integrated in a mobile device, or a body-mounted camera, for example. In an example scenario such as at the aforementioned stadium, four cameras with integrated audio capture devices, such as microphones, may be positioned at each of the four entrances to monitor crowd behavior. Each of the cameras may transmit a video signal for the corresponding entrance to a control room to be monitored and to a server for crowd behavior analysis.

The signal processor 204 may include a computing device such as a server, a desktop computer, a mobile computer, a special purpose computing device, or a component level processor, for example. In some examples, the signal processor 204 may be integrated with the plurality of devices in the monitor system 202. The signal processor 204 may receive crowd characteristics from the monitor system 202 or extract crowd characteristics from a video signal provided by the monitor system 202. The crowd characteristics may include a number of people that enter and exit an area during a particular time period, a difference in the number of people that enter and exit an area during the particular time period, a predominant direction of people's movement in the particular time period. The crowd characteristics may also include a difference in direction of people's movement in the particular time period, a speed of people's movement in the particular time period, a difference in speed of people's movement in the particular time period, a flow ratio of people in the particular time period, or a type of people in the particular time period, for example. After receiving the crowd characteristic for an area, the signal processor 204 may derive crowd behavior information for an area based on the crowd characteristics from the area, normalized crowd behavior information, crowd behavior information from other areas and/or external information. The external information may include a type of event being monitored, a time of an event, related actions to a particular event, a promotion associated with the event, or a number of attendees, for example.

In some examples, the signal processor 204 may identify a first area and at least a second area that are associated with similar crowd behavior. For example, at the stadium, the server may identify the four entrances as having similar crowd behavior. The signal processor 204 may correlate differences in crowd behavior information between the first area and at least the second area with the characteristics of the two areas. Area characteristics may include the size of an area, the shape of an area, a structural feature of an area, a decorative item within an area, a functional item within an area, another facility proximal to an area, or external traffic near an area, among other things. For example, at the stadium, the server may correlate that crowds move faster through the first entrance because the first entrance is wider than the other entrances.

The signal processor 204 may normalize crowd behavior information for a plurality of areas based on correlations made between crowd characteristics and area characteristics. In some examples, the signal processor 204 may utilize the normalized crowd behavior information to predict crowd behavior in an area. The signal processor 204 may also utilize a history of crowd characteristics, area characteristics, or external information to predict crowd behavior. For example, at the stadium, the server may normalize crowd characteristics from the first entrance and the second entrance to predict how fast a crowd may move through the third and fourth entrances. The server may also use crowd behavior data from the third and fourth entrances during past events to predict current crowd behavior. Correlation of differences in the crowd behavior information associated with two or more areas with area characteristics of the two or more areas may include detection of abnormalities, for example. The correlation may be used in normalization of the crowd behavior from different areas.

The signal processor 204 may provide the crowd characteristics, the area characteristics, a current crowd behavior, a predicted crowd behavior, and/or a difference between the current crowd behavior and the predicted crowd behavior for an area to be displayed on one or more display devices 206. The one or more display devices 206 may include a television, a mobile device, a monitor, a projector, or a tablet, for example. The one or more display devices 206 may receive a video signal corresponding to a surveillance area from the monitor system 202 as well as crowd characteristics, area characteristics, current crowd behavior, predicted crowd behavior, and/or a difference between current and predicted crowd behavior from the signal processor 204. In some examples, one of the display devices 206 may display the video signal for an area with an overlay of a visualization 208 of the crowd and area characteristics, current crowd behavior, the predicted crowd behavior, as well as differences between the current crowd behavior and the predicted crowd behavior. The superimposition of the visualization and the captured video (or image) may be performed by the signal processor 204 or another component of the security system. The visualization 208 may include different textual, graphical, coloring, highlighting, shading, or animation schemes to emphasize a difference between the predicted crowd behavior and the crowd or area characteristics.

In the example scenario at the stadium, a security guard may be positioned in a control room to monitor video signals from each of the four entrances while attendees arrive for a basketball game. The video signals may be provided to the monitors in the control room by the corresponding camera at each entrance. The server may provide a visualization of how fast a crowd is moving through each entrance, a prediction of how fast the crowd may dissipate outside, and a difference between the current speed of the crowd and the predicted speed on the corresponding video signal. The visualizations of predicted crowd behavior or the difference between the current and predicted speeds may help the security guard anticipate a crowd build-up at a certain gate and a need for more security personnel in the area, for example.

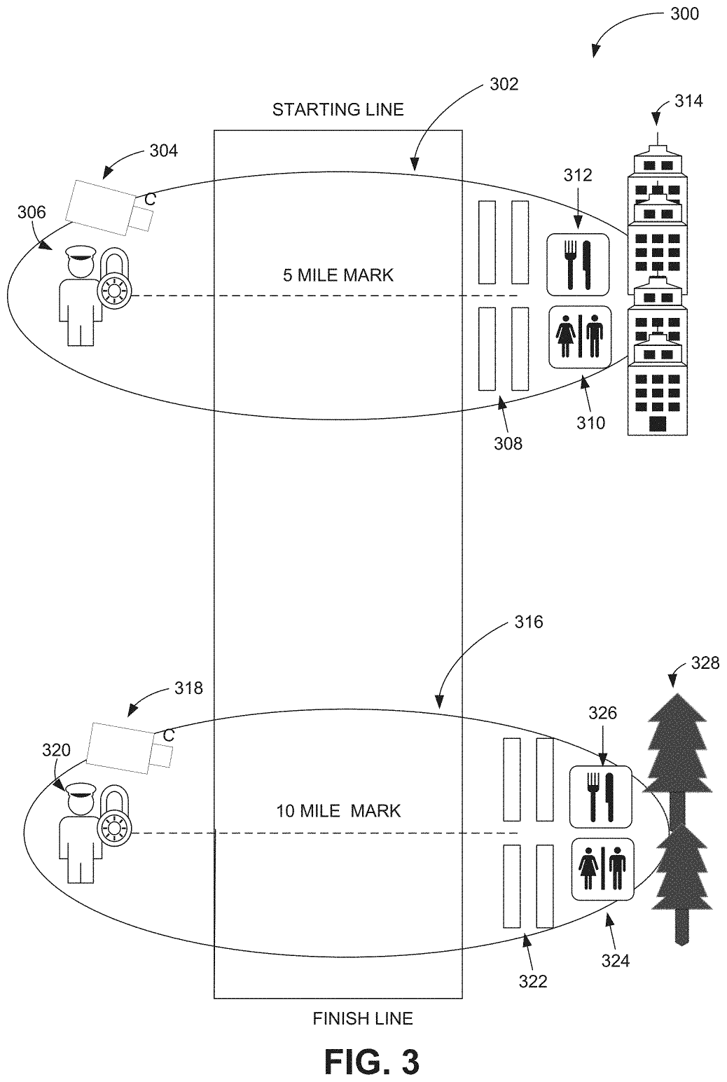

FIG. 3 illustrates an example scenario where predicted crowd behavior may be visualized for surveillance of a marathon, arranged in accordance with at least some embodiments described herein.

As shown in diagram 300, a first surveillance area 302 may correspond to the 5-mile mark in the marathon. The first surveillance area 302 may be monitored by an image capture device 304 and a police officer 306. The first surveillance area may include spectator seating 308, a pair of restrooms 310, and a food vendor area 312. The first surveillance area 302 may be located in the middle of a city and may be shaded by buildings 314, for example. The image capture device 304 may include a stationary camera, a mobile camera, a thermal camera, a camera integrated in a mobile device, or a body-mounted camera, for example. The image capture device 304 may transmit a video signal corresponding with the first surveillance area 302 to a signal processor to be analyzed for crowd behavior information and to a display device for monitoring.

A second surveillance area 316 may correspond to the 10-mile mark in the marathon. The second surveillance area 316 may be monitored by an image capture device 318 and a police officer 320. The second surveillance area 316 may include spectator seating 322, a pair of restrooms 324, and a food vendor area 326. In the example scenario, the second surveillance area 316 may be located in a park and be surrounded by trees 328. The image capture device 318 may include a stationary camera, a mobile camera, a thermal camera, a camera integrated in a mobile device, or a body-mounted camera, for example. The image capture device 318 may transmit a video signal corresponding with the second surveillance area 316 to a signal processor to be analyzed for crowd behavior information and to a display device for monitoring.

The signal processor may receive crowd characteristics corresponding with the first surveillance 302 and the second surveillance area 316. In some examples, the signal processor may receive crowd characteristics by extracting crowd characteristics from a video signal. The signal processor may derive crowd behavior information from the crowd characteristics for the first surveillance area 302 and the second surveillance area 316 throughout the race. The signal processor may also normalize crowd behavior for the first surveillance area 302 as the runners pass the five-mile mark at an early time point in the race, such as how lines form in the food vendor area 312 or how spectators exit the spectator seating 308 after the runners have passed.

In other examples, the signal processor may identify the first surveillance area 302 and the second surveillance area 316 as being associated with similar crowd behaviors and may correlate differences in crowd behavior with different area characteristics. The signal processor may predict crowd behavior in the second surveillance area 316 based on current crowd behavior information, the normalized crowd behavior from the first surveillance area 302, and/or external information. For example, the signal processor may predict that lines at the food vendor area 326 will take 10 minutes longer to dissipate than at the food vendor area 312 because there are larger food trucks than in the food vendor area 312.

The signal processor may send the predicted crowd behaviors to a display device to be visualized. The display device may include a television, a mobile device, a monitor, a projector, or a tablet, for example. The display device may display the video signal from the area with an overlay of the predicted crowd behavior, current crowd behavior, area characteristics, and/or differences between the predicted crowd behavior and the current crowd behavior. In the example scenario, the signal processor may provide the video signal from the image capture device 318 overlaid with a visualization of the predicted crowd behavior to the police officer 320 on a mobile device and the current crowd behavior. The visualization may include the prediction that the lines in the food vendor area 326 will take 20 minutes to dissipate based on the where the food trucks are parked and the current crowd behavior. Additional visualizations may be provided to highlight differences between the predicted speed the crowd dissipates and the actual speed. For example, the video signal may be overlaid with an indication that the crowd is dissipating slower than anticipated and a visualization highlight a group of people loitering in a critical area. The police officer may utilize the additional visualizations to identify the group of people and ask them to clear the area. In yet other examples, predicted crowd behavior or other information may be displayed without being overlaid on a video feed of the crowd.

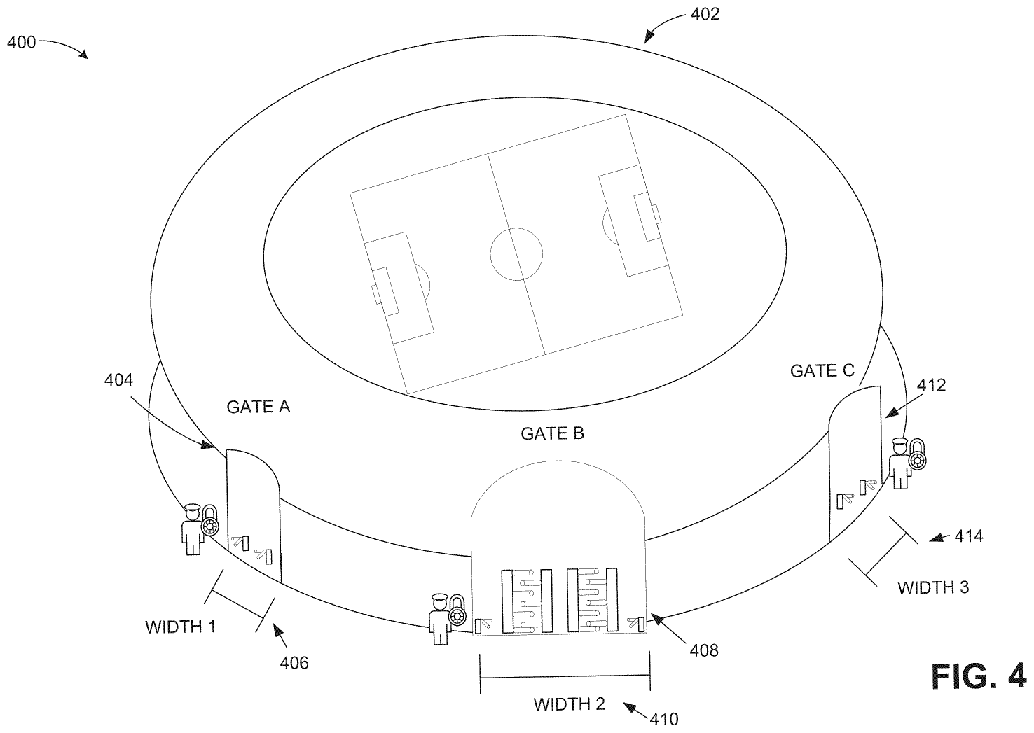

FIG. 4 illustrates another example scenario where predicted crowd behavior may be visualized for surveillance of a sporting event, arranged in accordance with at least some embodiments described herein.

As shown in the example scenario depicted in diagram 400, a basketball game may be taking place at a stadium 402. The stadium 402 may have three entrances of varying widths that are monitored by security personnel. The first entrance 404, or Gate A, may have a first width 406; the second entrance 408, or Gate B, may have a second width 410, and the third entrance 412, or Gate C, may have a third width 414.

In the example scenario, there may be a three games series taking place at the stadium 402. Throughout the series, each of the entrances may be monitored by an image capture device such as a camera. The cameras may transmit a corresponding video signal for each entrance to a display device to be monitored and to a signal processor, such as a server, to be analyzed. The signal processor, or the server in the example scenario, may extract crowd characteristics from each video signal and derive crowd behavior information for each entrance. During the first game, the second entrance 408 may be closed due to renovations that were not completed on time. The server may identify that the first entrance 404 and the third entrance 412 are both associated with similar crowd behaviors. The server may identify that the first width 406 and the third width 414 are similar and may normalize crowd behaviors at the first entrance 404 and the third entrance 412 throughout the first game. The renovations on the second entrance 408 may be completed the next day, and the second entrance 408 may be open for the second game. The server may use the normalized crowd behaviors from the first entrance 404 and the third entrance 412 and characteristics of the area to predict crowd behavior at the second entrance 408 throughout the second game. The server may predict, for example, that crowds may move more quickly through the second entrance 408 because the second width 410 is twice as large the first width 406 and the third width 414.

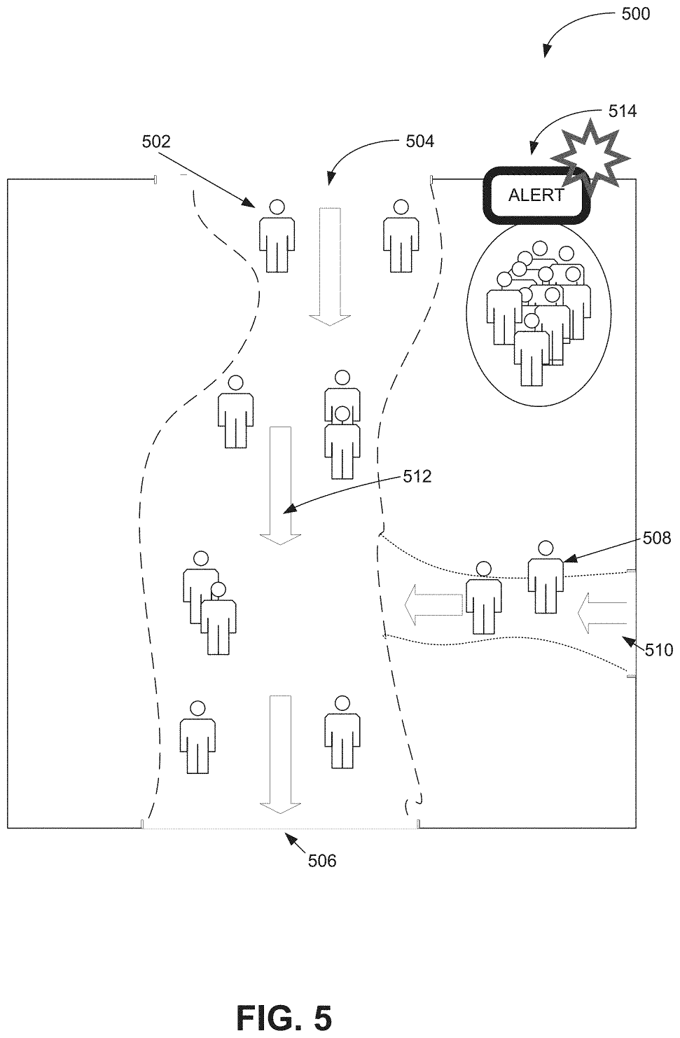

FIG. 5 illustrates an example visualization of predicted crowd behavior associated with a main area of a mall, arranged in accordance with at least some embodiments described herein.

As shown in diagram 500, a display device of a security control center may display a video signal with visualizations of current and predicted crowd behavior. The video may include an average crowd of customers 502 walking along a corridor 504 toward the exit 506. Additional customers 508 may be shown entering the corridor 504 from a service hallway 510. The video signal may be transmitted from an image capture device of a monitor system positioned in the corridor 504. The monitor system may include a plurality of image capture devices positioned throughout the mall to capture video signals.

The image capture device may transmit the video signal from the corridor to a signal processor. The signal processor may extract crowd characteristics from the video signal and derive crowd behavior information from the crowd characteristics. The signal processor may also predict crowd behaviors in the corridor based on normalized crowd behaviors, current crowd characteristics, area characteristics, and/or external factors. The signal processor may transmit the current crowd behavior information and/or predicted crowd behavior information to the display device.

The display device may overlay the video signal with visualizations of the current crowd behavior such as the arrows 512 indicating a predominant direction of traffic. The display device may also overlay the video signal with a predicted crowd behavior such as an alert 514 that the number of customers in the corridor may rapidly increase due to an emergency. For example, the signal processor may normalize how customers exit the mall on a typical day through the corridor 504 or through other exit corridors and may be able to predict crowd behaviors when an emergency occurs. In the example scenario, a fire alarm may cause a crowd of customers rush toward the exit 506. The signal processor may receive the video signal of the corridor 504 during the fire alarm and extract the crowd characteristics. The signal processor may predict the crowd of customers 502 may grow and move more rapidly in response to the fire alarm and may transmit the prediction to the display device. The display device may overlay the video signal with the alert 514 indicating that the crowd of customers 502 may increase in size and/or speed, thus creating a potential danger in the area.

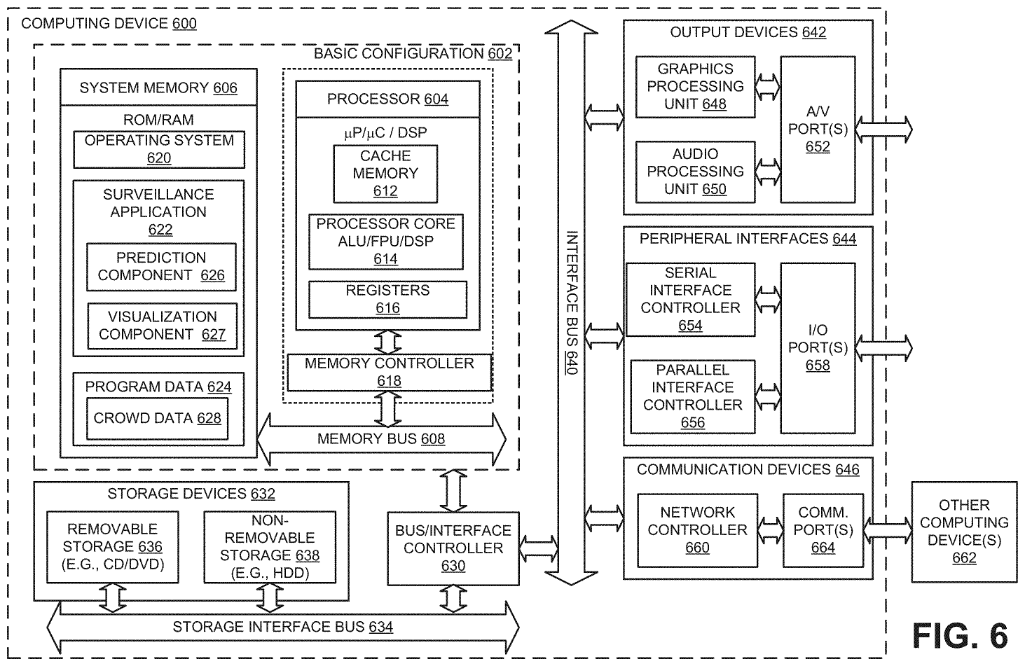

FIG. 6 illustrates a computing device, which may be used to visualize predicted crowd behavior for surveillance, arranged with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include a prediction component 626 and a visualization component 627. The surveillance application 622 may be configured to send and/or receive audio and video signals associated with surveillance, among other things. The prediction component 626 may be configured to receive crowd characteristics for an area, derive current crowd behavior information from the crowd characteristics, and predict crowd behavior information from crowd characteristics, area characteristics, normalized crowd information, and/or external information. The visualization component 627 may be configured to overlay a visualization of the predicted crowd behavior information on a corresponding video signal. The visualization may include different textual, graphical, coloring, highlighting, shading, or animation schemes to emphasize a difference between the predicted crowd behavior and the crowd or area characteristics. The program data 624 may include, among other data, crowd data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

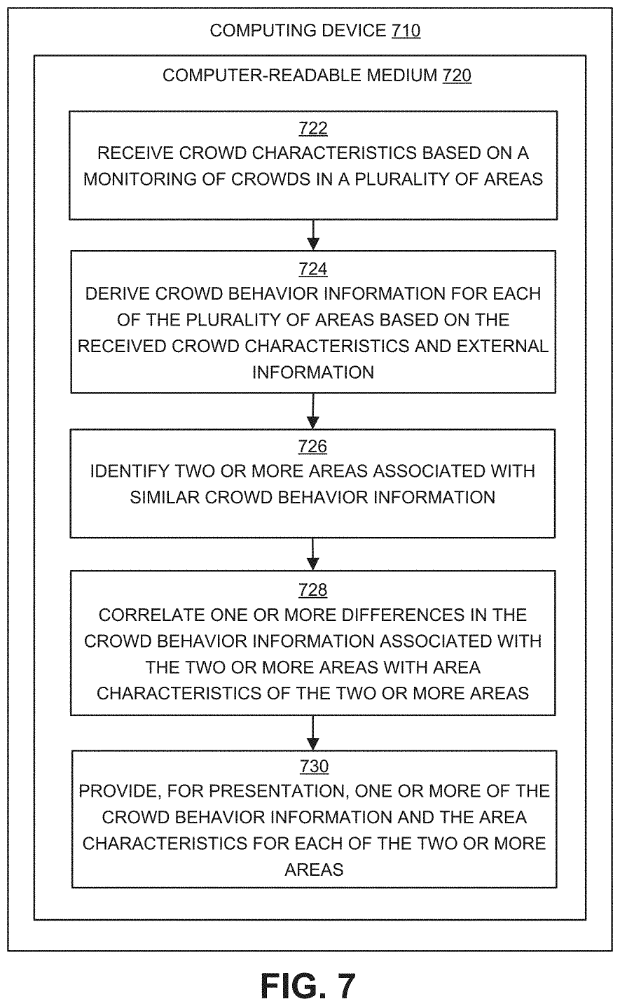

FIG. 7 is a flow diagram illustrating an example method to visualize predicted crowd behavior for surveillance that may be performed by a computing device such as the computing device in FIG. 6, arranged with at least some embodiments described herein.

Example methods may include one or more operations, functions or actions as illustrated by one or more of blocks 722, 724, 726, 728 and/or 730, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions or actions, and need not necessarily be performed in the exact sequence as shown. The operations described in the blocks 722-730 may also be implemented through execution of computer-executable instructions stored in a computer-readable medium such as a computer-readable medium 720 of a computing device 710.

An example process to visualize predicted crowd behavior for surveillance may begin with block 722, “RECEIVE CROWD CHARACTERISTICS BASED ON A MONITORING OF CROWDS IN A PLURALITY OF AREAS”, where crowd characteristics may be received from a plurality of image capture devices in corresponding surveillance areas. The crowd characteristics may be extracted from a video signal received from a plurality of image capture devices in corresponding surveillance areas. Crowd characteristics may include a number of people that enter and exit an area during a particular time period, a predominant direction of people's movement in the particular time period, a speed of people's movement in the particular time period, a flow ratio of people in the particular time period, or a type of people in the particular time period, for example.

Block 722 may be followed by block 724, “DERIVE CROWD BEHAVIOR INFORMATION FOR EACH OF THE PLURALITY OF AREAS BASED ON THE RECEIVED CROWD CHARACTERISTICS AND EXTERNAL INFORMATION”, where crowd behavior information may be derived from the received crowd characteristics and external information. The external information may include one or more of a type of event associated with the surveillance, a timing of the event, related actions to the event, or a promotion associated with the event.

Block 724 may be followed by block 726, “IDENTIFY TWO OR MORE AREAS ASSOCIATED WITH SIMILAR CROWD BEHAVIOR INFORMATION”, where two areas may be identified as having similar crowd behaviors. For example, two or more entrances to a stadium may be identified for similar crowd behaviors during events.

Block 726 may be followed by block 728, “CORRELATE ONE OR MORE DIFFERENCES IN THE CROWD BEHAVIOR INFORMATION ASSOCIATED WITH THE TWO OR MORE AREAS WITH AREA CHARACTERISTICS OF THE TWO OR MORE AREAS”, where differences in crowd behavior may be correlated with differing area characteristics. Area characteristics may include the size of an area, the shape of an area, a structural feature of an area, a decorative item within an area, a functional item within an area, another facility proximal to an area, or external traffic near an area among other things.

Block 728 may be followed by block 730, “PROVIDE, FOR PRESENTATION, ONE OR MORE OF THE CROWD BEHAVIOR INFORMATION AND THE AREA CHARACTERISTICS FOR EACH OF THE TWO OR MORE AREAS”, where the crowd behavior information and the area characteristics may be provided to a display device for visualization. The display device may be configured to overlay a corresponding video signal with a visualization of the crowd behavior information and the area characteristics.

The operations included in the example process are for illustration purposes. Visualization of crowd behavior information for surveillance may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

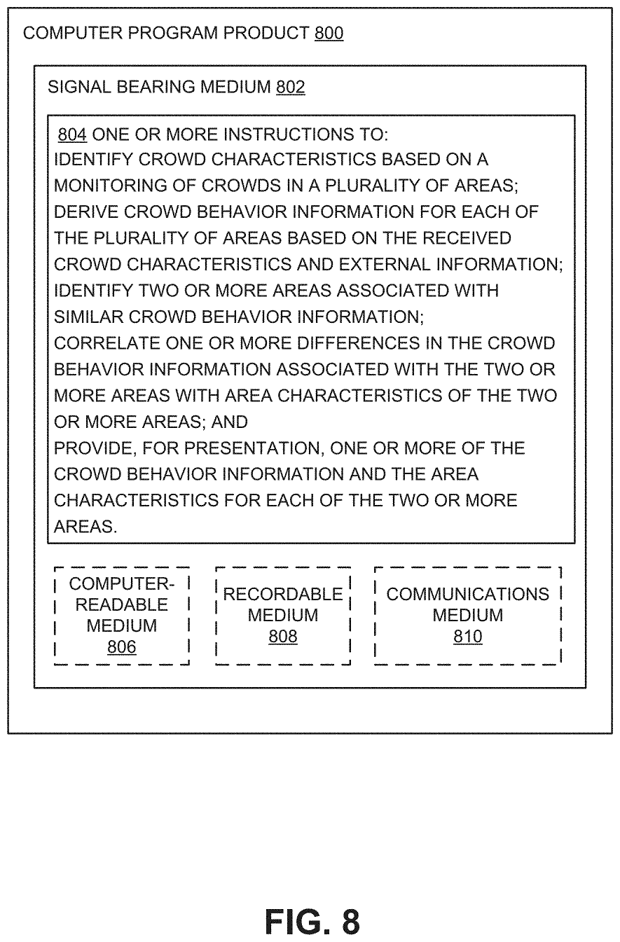

FIG. 8 illustrates a block diagram of an example computer program product, some of which are arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal bearing medium 802 to perform actions associated with the visualization of crowd behavior information for surveillance as described herein. Some of those instructions may include, for example, identify received crowd characteristics based on a monitoring of crowds in a plurality of areas; derive crowd behavior information for each of the plurality of areas based on the received crowd characteristics and external information; identify two or more areas associated with similar crowd behavior information; correlate one or more differences in the crowd behavior information associated with the two or more areas with area characteristics of the two or more areas; and provide, for presentation, one or more of the crowd behavior information and the area characteristics for each of the two or more areas, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples, a method to visualize predicted crowd behavior for surveillance may comprise receiving crowd characteristics based on a monitoring of crowds in a plurality of areas, deriving crowd behavior information for each of the plurality of areas based on the received crowd characteristics and external information, identifying two or more areas associated with similar crowd behavior information, correlating one or more differences in the crowd behavior information associated with the two or more areas with area characteristics of the two or more areas, and providing, for presentation, one or more of the crowd behavior information and the area characteristics for each of the two or more areas.

In other examples, the method may further comprise normalizing the crowd behavior information associated with the two or more areas based on the correlation, which may include a first area and a second area. In further examples, the method may further comprise receiving crowd characteristics for the second area determined from a monitoring of the second area, predicting a crowd behavior for the first area based on the normalized crowd behavior information and based on the received crowd characteristics for the second area, and visualizing the predicted crowd behavior for the first area. In other examples, the method may further comprise receiving crowd characteristics for the first area determined from a monitoring of the first area and employing one or more of textual, graphical, coloring, highlighting, shading, or animation schemes in the visualization of the predicted crowd behavior for the first area to emphasize a difference between the predicted crowd behavior for the first area and the received crowd characteristics for the first area. In further examples, the method may further comprise providing the visualization of the predicted crowd behavior for the first area to a display device for display, and the display device may be configured to overlay the visualization of the predicted crowd behavior for the first area on a video signal of the first area captured by a monitor system.

In still further examples, the method may comprise receiving a history of crowd characteristics based on past monitoring of crowds in the plurality of areas and deriving additional crowd behavior information for each of the plurality of areas based on the received history of crowd characteristics and the external information. In some examples, identifying the two or more areas associated with similar crowd behavior information may comprise identifying the two or more areas associated with similar crowd behavior information based on the crowd behavior information and the additional crowd behavior information.

In other examples, the crowd characteristics may include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period. In some examples, the external information may include one or more of a type of event associated with the surveillance, a timing of the event, related actions to the event, or a promotion associated with the event. In further examples, the area characteristics may include one or more of an area size, an area shape, a structural feature of an area, a decorative item within an area, a functional item within an area, another facility proximal to an area, or external traffic near an area.

In further examples, receiving crowd characteristics based on the monitoring of the crowds in the plurality of areas may comprise receiving one or more video signals captured by a monitor system for each of the plurality of areas and extracting the crowd characteristics for each of the plurality of areas from the one or more video signals. In some examples, the monitor system may comprise at least one image capture device located in each of the plurality of areas configured to capture the one or more video signals.

According to other embodiments, a server may be configured to visualize predicted crowd behavior for surveillance. The server may be comprised of a communication interface which may be configured to facilitate communication between a monitor system and the server and a processor coupled to the communication interface. The processor may be configured to perform or control performance of: receive, from the communication interface, crowd characteristics based on crowds in a plurality of areas being monitored by the monitor system; derive crowd behavior information for each of the plurality of areas based on the received crowd characteristics and external information; identify two or more areas associated with similar crowd behavior information; correlate one or more differences in the crowd behavior information associated with the two or more areas with area characteristics of the two or more areas; normalize the crowd behavior information associated with the two or more areas based on the correlation; and provide, for presentation, the normalized crowd behavior information associated with the two or more areas.

In some embodiments, the server and the monitor system may be components of a surveillance system, and the monitor system may comprise at least one image capture device located in each of the plurality of areas and configured to capture one or more video signals for each of the plurality of areas. In further embodiments, the crowd characteristics for each of the plurality of areas may be extracted from the one or more video signals.

In other embodiments, the two or more areas may include a first area and a second area, and the processor may be further configured to perform or control performance of: receive, from the communication interface which in turn received from the monitor system, crowd characteristics for the second area determined from a monitoring of the second area; and predict a crowd behavior for the first area based on the normalized crowd behavior information and based on the received crowd characteristics for the second area. In some embodiments, the processor may be further configured to perform or control performance of: receive, from the communication interface which in turn received from the monitor system, crowd characteristics for the first area determined from a monitoring of the first area; and visualize the predicted crowd behavior for the first area, wherein one or more of textual, graphical, coloring, highlighting, shading, or animation schemes are employed in the visualization to emphasize a difference between the predicted crowd behavior for the first area and the received crowd characteristics for the first area.

In further embodiments, the processor may be further configured to perform or control performance of: provide the visualization of the predicted crowd behavior for the first area to a display device for display. In some embodiments, the display device may be configured to overlay the visualization of the predicted crowd behavior for the first area on a video signal of the first area captured by the monitor system, and the communication interface may be further configured to facilitate communication between the server and the display device.

In some embodiments, the processor may be further configured to perform or control performance of: receive, from the communication interface, a history of crowd characteristics based on past monitoring of crowds in the plurality of areas, wherein the communication interface is configured to receive the history of crowd characteristics from a data store associated with the monitor system; derive additional crowd behavior information for each of the plurality of areas based on the received history of crowd characteristics and external information; and identify the two or more areas associated with similar crowd behavior information based on the crowd behavior information and the additional crowd behavior information.

In further embodiments, the crowd characteristics may include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period. In some embodiments, wherein the external information may include one or more of a type of event associated with the surveillance, a timing of the event, related actions to the event, or a promotion associated with the event. In other embodiments, the area characteristics may include one or more of an area size, an area shape, a structural feature of an area, a decorative item within an area, a functional item within an area, another facility proximal to an area, or external traffic near an area.

According to some examples, a system may be configured to visualize predicted crowd behavior for surveillance. The system may be comprised of a monitor system, a display device, a server, and a communication interface configured to facilitate communication between the monitor system, the display device, and the server. The monitor system may be configured to monitor crowds in a plurality of areas. The server may comprise a processor configured to: receive, from the communication interface, crowd characteristics based on the monitoring of the crowds in the plurality of areas, wherein the communication interface receives the crowd characteristics from the monitor system; derive crowd behavior information for each of the plurality of areas based on the received crowd characteristics and external information; identify two or more areas associated with similar crowd behavior information; correlate one or more differences in the crowd behavior information associated with the two or more areas with area characteristics of the two or more areas; normalize the crowd behavior information associated with the two or more areas based on the correlation to predict a crowd behavior for a first area of the two or more areas; and provide, to the display device for presentation, the predicted crowd behavior for the first area.

In other examples, the system may include a surveillance system, and the monitor system may comprise at least one image capture device located in each of the plurality of areas configured to capture one or more video signals for each of the plurality of areas in order to monitor the crowds. In further examples, the crowd characteristics for each of the plurality of areas may be extracted from the one or more video signals. In some examples, the two or more areas may include the first area and a second area and, to predict the crowd behavior for the first area, the processor may be configured to perform or control performance of: receive, from the communication interface which in turn received from the monitor system, crowd characteristics for the second area determined from a monitoring of the second area; and predict the crowd behavior for the first area based on the normalized crowd behavior information and based on the received crowd characteristics for the second area.

In further examples, in order to provide the predicted crowd behavior for the first area for presentation, the processor may be configured to: receive, from the communication interface which in turn received from the monitor system, crowd characteristics for the first area determined from a monitoring of the first area; and visualize the predicted crowd behavior for the first area, wherein one or more of textual, graphical, coloring, highlighting, shading, or animation schemes are employed in the visualization to emphasize a difference between the predicted crowd behavior for the first area and the received crowd characteristics for the first area. According to some examples, the display device may be configured to: receive, from the server, the visualization of the predicted crowd behavior for the first area; receive, from the monitor system, a video signal of the first area captured by the monitor system; and overlay the visualization on the video signal of the first area for display. In some examples, the display device may include one of: a television, a computing device, a monitor, or a projection screen.

In other examples, the processor may be further configured to perform or control performance of: receive, from a data store associated with the monitor system, a history of crowd characteristics based on past monitoring of crowds in the plurality of areas; derive additional crowd behavior information for each of the plurality of areas based on the received history of crowd characteristics and external information; and identify the two or more areas associated with similar crowd behavior information based on the crowd behavior information and the additional crowd behavior information.

According to further examples, the crowd characteristics may include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period. In other examples, the external information may include one or more of a type of event associated with the surveillance, a timing of the event, related actions to the event, or a promotion associated with the event. In some examples, the area characteristics may include one or more of an area size, an area shape, a structural feature of an area, a decorative item within an area, a functional item within an area, another facility proximal to an area, or external traffic near an area.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to visualize predicted crowd behavior for surveillance, the method comprising:
receiving crowd characteristics and area characteristics for a first crowd in a first area and a second crowd in a second area based on a monitoring of the first and second crowds;
deriving crowd behavior information for the first crowd in the first area and the second crowd in the second area based on the received crowd characteristics;
identifying the first area and the second area as being associated with similar crowd behavior information;
correlating one or more differences in the crowd behavior information associated with the first area and the second area with area characteristics of the first area and the second area; and
providing, for presentation, one or more of the crowd behavior information and the area characteristics for the first area and the second area.

2. (canceled)

3. The method of claim 1, further comprising:
receiving crowd characteristics for the second area determined from a monitoring of the second area;
normalizing the crowd behavior information for the second area based on the area characteristics of the second area; and predicting a crowd behavior for the first area based on the normalized crowd behavior information for the second area.

4. (canceled)

5. The method of claim 3, further comprising:
visualizing the predicted crowd behavior for the first area by:
employing one or more of textual, graphical, coloring, highlighting, shading, or animation schemes to emphasize a difference between the predicted crowd behavior for the first area and the received crowd characteristics for the first area.

6. The method of claim 3, further comprising:
visualizing the predicted crowd behavior for the first area; and
providing the visualization of the predicted crowd behavior for the first area to a display device to be displayed on a video signal of the first area captured by a monitor system.

7. (canceled)

8. The method of claim 1, further comprising:
receiving a history of crowd characteristics based on past monitoring of the first crowd in the first area and the second crowd in the second area; and
deriving additional crowd behavior information for each of the first area and the second area based on the received history of crowd characteristics.

9. (canceled)

10. The method of claim 1, wherein the crowd characteristics include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period.

11. The method of claim 1, further comprising:
deriving the crowd behavior information for the first crowd in the first area and the second crowd in the second area further based on external information, wherein the external information includes one or more of a type of event associated with the surveillance, a timing of the event, related actions to the event, or a promotion associated with the event.

12. The method of claim 1, wherein the area characteristics include one or more of an area size, an area shape, a structural feature of an area, a decorative item within an area, a functional item within an area, another facility proximal to an area, or external traffic near an area.

13. (canceled)

14. (canceled)

15. The method of claim 1, wherein receiving crowd characteristics for the first crowd in the first area and the second crowd in the second area comprises:
receiving one or more audio signals and one or more image signals captured by a monitor system for the first area and the second area; and
extracting the crowd characteristics for each of the first area and the second area from the one or more audio signals and the one or more image signals.

16. (canceled)

17. A server configured to visualize predicted crowd behavior for surveillance, the server comprising:
a communication interface configured to facilitate communication between a monitor system and the server;
a processor coupled to the communication interface, wherein the processor is configured to perform or control performance of:
receive, from the communication interface, crowd characteristics and area characteristics for a first crowd in a first area and a second crowd in a second area based on the first crowd and the second crowd being monitored, respectively, in the first area and the second area by the monitor system;
derive crowd behavior information for the first crowd in the first area and the second crowd in the second area based on the received crowd characteristics;
identify the first area and the second area as being associated with similar crowd behavior information;
correlate one or more differences in the crowd behavior information associated with the first area and the second area with area characteristics of the first area and the second area;
normalize the crowd behavior information associated with the first area and the second area based on the correlation; and
provide, for presentation, the normalized crowd behavior information associated with the first area and the second area.

18. (canceled)

19. The server of claim 17, wherein the monitor system comprises:
at least one image capture device located in the first area and the second area and configured to capture one or more video signals for the first area and the second area; and
at least one microphone and at least one sensor located in the first area and the second area configured to capture one or more audio signals and one or more image signals, respectively.

20. The server of claim 19, wherein the processor is further configured to perform or control performance of:
extract the crowd characteristics for the first area and the second area from one or more of the one or more video signals, the one or more audio signals, and the one or more image signals.

21.-23. (canceled)

24. The server of claim 17, wherein the processor is further configured to perform or control performance of:
visualize the crowd behavior for the first area, wherein one or more of textual, graphical, coloring, highlighting, shading, or animation schemes are employed in the visualization to emphasize a difference between the crowd behavior for the first area and the received crowd characteristics for the first area.

25.-28. (canceled)

29. The server of claim 17, wherein
the crowd characteristics include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period; and
the area characteristics include one or more of an area size, an area shape, a structural feature of an area, a decorative item within an area, a functional item within an area, another facility proximal to an area, or external traffic near an area.

30. The server of claim 17, wherein the processor is further configured to perform or control performance of:
derive the crowd behavior information for the first crowd in the first area and the second crowd in the second area further based on external information, wherein the external information includes one or more of a type of event associated with the surveillance, a timing of the event, related actions to the event, or a promotion associated with the event.

31. (canceled)

32. A system configured to visualize predicted crowd behavior for surveillance, the system comprising:
a monitor system;
a display device;
a server; and
a communication interface configured to facilitate communication between the monitor system, the display device, and the server, wherein
the monitor system is configured to monitor crowds in a plurality of areas, and
the server comprises a processor configured to:
receive, from the communication interface, crowd characteristics and area characteristics for a first crowd in a first area and a second crowd in a second area based on the first crowd and the second crowd being monitored, respectively, in the first area and the second area by the monitor system, wherein the communication interface receives the crowd characteristics from the monitor system;
derive crowd behavior information for the first crowd in the first area and the second crowd in the second area based on the received crowd characteristics;
identify the first area and the second area as being associated with similar crowd behavior information;
correlate one or more differences in the crowd behavior information associated with first area and the second area with area characteristics of the first area and the second area;
normalize the crowd behavior information associated with the first area and the second area based on the correlation to predict a crowd behavior for the first area; and
provide, to the display device for presentation, the predicted crowd behavior for the first area.

33. (canceled)

34. The system of claim 32, wherein the monitor system comprises:
at least one image capture device located in the first area and the second area configured to capture one or more video signals for the first area and the second area in order to monitor the crowds; and
at least one microphone and at least one sensor located in the first area and the second area configured to capture one or more audio signals and one or more image signals, respectively, wherein the crowd characteristics for the first area and the second area are extracted from the one or more video signals, the one or more audio signals, or the one or more image signals.

35.-39. (canceled)

40. The system of claim 32, wherein the display device is configured to:
receive, from the server, the visualization of the predicted crowd behavior for the first area;
receive, from the monitor system, a video signal of the first area captured by the monitor system; and
overlay the visualization on the video signal of the first area for display.

41. (canceled)

42. The system of claim 32, wherein the processor is further configured to perform or control performance of:
receive, from a data store associated with the monitor system, a history of crowd characteristics based on past monitoring of crowds in the first area and the second area;
derive additional crowd behavior information for the first area and the second area based on the received history of crowd characteristics and external information; and
identify the first area and the second area as being associated with similar crowd behavior information based on the crowd behavior information and the additional crowd behavior information.

43. The system of claim 32, wherein
the crowd characteristics include one or more of a number of people that enter and exit each of the plurality of areas in a particular time period, a predominant direction of people's movement in the particular time period, a speed of people's movement in the particular time period, a flow ratio of people in the particular time period, or a type of people in the particular time period; and
the area characteristics include one or more of an area size, an area shape, a structural feature of an area, a decorative item within an area, a functional item within an area, another facility proximal to an area, or external traffic near an area.

44. The system of claim 32, wherein the processor is further configured to perform or control performance of:
derive crowd behavior information for the first crowd in the first area and the second crowd in the second area further based on external information, wherein the external information includes one or more of a type of event associated with the surveillance, a timing of the event, related actions to the event, or a promotion associated with the event.

45. (canceled)
